(19) United States
(12) Patent Application Publication
(10) Pub. No.: US 2012/0052803 A1
(43) Pub. Date: Mar. 1, 2012

(54) Cellular Telephone Apparatus

(76) Inventor: Meir FEDIDA, Rishon Lezion (IL)

(21) Appl. No.: 13/050,011

(22) Filed: Mar. 17, 2011

(30) Foreign Application Priority Data
Sep. 1, 2010 (IL) 207920

(51) Int. Cl. H04B 7/00; H04W 88/02

(52) U.S. Cl. 455/41.2

(57) ABSTRACT

In one aspect, the present invention is directed to a cellular telephone apparatus (2), comprising: a “traditional” handset (10); and a communication box (20) in which is installed at least a cellular transmitter of the apparatus (2). The handset (10) and the communication box (20) are physically separate entities, communicating with each other via short range communication (32a, 32b). The result allows a user thereof to carry out cellular communication while keeping the cellular transmitter away from his head.

### FIELD OF THE INVENTION

The present invention relates to the field of cellular telephone devices. More particularly, the invention relates to a cellular telephone apparatus that exposes the user thereof to reduced radiation.

### BACKGROUND OF THE INVENTION

How cellular phone radiation may affect the health of users has excited considerable interest and research, due to the immense popularity of these devices throughout the world. Electromagnetic radiation in the microwave range, used by cellular phones, is considered by some to be potentially harmful to health. Thus far, extensive research, both epidemiological and experimental, on animals and humans, has revealed nothing suggestive of harmful effects.

Based upon the consensus view of the scientific and medical communities, The World Health Organization has declared that cellular phones and their base stations are highly unlikely to cause cancer. Further, the WHO states that no convincing evidence has been presented suggesting other health risks posed by cellular phones. Certain national radiation advisory authorities have, however, recommended measures designed to minimize citizens' radiation exposure as a precautionary approach.

When a cellular telephone handset is at a distance less than 10 cm from a user's head, the strength of the radio “reactive field” of the transmission is relatively “strong”. The strength is reduced exponentially as this distance increases. This fact has been used by cellular telephone enterprises that have tried to solve this problem.

One of the solutions to the radiation problem is wired headphones. Using headphones, a cellular phone handset can be kept away from the user's head when having a telephone conversation.

Another solution is providing the cellular handset a loudspeaker, thereby allowing keeping the handset away from the user's head.

Another solution is a Bluetooth headphone, i.e., a headphone that communicates with the telephone handset via the Bluetooth protocol (“wireless headphones”).

Each of these solutions has its own drawbacks: the use of wired headphones is cumbersome, speech played by a speaker sometimes does not sound clear as the played sound reaches also to the telephone's microphone, and wireless headphones requires a relatively-small battery, which has to be often recharged due its relatively-small physical size, which limits its capacity and accordingly its operation time.

It is an object of the present invention to provide a solution to the above-mentioned and other problems of the prior art.

Other objects and advantages of the invention will become apparent as the description proceeds.

### SUMMARY OF THE INVENTION

Thus, the term “short range wireless communication” refers herein to wireless (e.g., radio) communication within a distance of about one meter up to a few meters, e.g., 10 meters.

In one aspect, the present invention is directed to a cellular telephone apparatus (2), comprising: a “traditional” handset (10); and a communication box (20) in which is installed at least a cellular transmitter of the apparatus (2). The handset (10) and the communication box (20) are physically separate entities, communicating with each other via short range communication (32a, 32b). The result allows a user thereof to carry out cellular communication while keeping the cellular transmitter away from his head.

Preferably, the short range communication is a Bluetooth communication (i.e., complies with the Bluetooth protocol), which allows keeping the short-range communication confidential.

Preferably, the range of the short-range wireless communication is about 1 meter, thereby using a relatively low power transmitter, which allows using the battery for a longer time in comparison to communication within a longer distance.

The range of the short range wireless communication is within about 10 meters, thereby allowing utilizing the handset while charging the communication box.

The communication box may further comprise a cellular receiver, thereby concentrating the cellular communication components of the apparatus nearby each other, which allows using a simplified mechanism. An additional benefit of this configuration is convenient maintenance, since the entire communication box may be replaced.

The handset may further comprise housing for holding therein the box. According to one embodiment of the invention, the housing comprises contacts connected to a charging slot thereof, and the box comprises corresponding contacts, thereby allowing charging the handset and the box simultaneously, by the same charger.

The box may further comprise a clip, for clipping the box to a garment of the user.

In one embodiment of the invention, the short range communication is carried out alternately on idle time, and continuously while communicating (having a telephone conversation) with another user, thereby using a reduced amount of energy.

In another aspect, the present invention is directed to a method for reducing radiation of a cellular telephone to a user's head, the method comprising the steps of: physically separating the cellular transmitter of the cellular telephone from the handset of the cellular telephone; and replacing the wired connection of the transmitter with components of the cellular telephone by short range wireless communication means; thereby allowing disposing the transmitter away from the user's head, resulting in reduced cellular radiation for the transmitter to the user's head.

The reference numbers have been used to point out elements in the embodiments described and illustrated herein, in order to facilitate the understanding of the invention. They are meant to be merely illustrative, and not limiting. Also, the foregoing embodiments of the invention have been described and illustrated in conjunction with systems and methods thereof, which are meant to be merely illustrative, and not limiting.

### BRIEF DESCRIPTION OF THE DRAWINGS

Embodiments and features of the present invention are described herein in conjunction with the following drawings:

FIG. 1 pictorially illustrates a cellular telephone apparatus 2, according to a preferred embodiment of the invention.

FIG. 2 pictorially illustrates the backside of communication box 20 of FIG. 1.

FIG. 3 pictorially illustrates a communication transmission from a cellular telephone A to a cellular telephone B, according to one embodiment of the invention.

FIG. 4 pictorially illustrates a cellular telephone apparatus, according to another embodiment of the invention.

FIG. 5 is a block diagram illustrating a cellular telephone, according to the prior art.

FIG. 6 is a block diagram illustrating a cellular telephone, according to one embodiment of the invention.

It should be understood that the drawings are not necessarily drawn to scale.

### DETAILED DESCRIPTION OF PREFERRED EMBODIMENTS

The present invention will be understood from the following detailed description of preferred embodiments, which are meant to be descriptive and not limiting. For the sake of brevity, some well-known features, methods, systems, procedures, components, circuits, and so on, are not described in detail.

According to the prior art, a cellular telephone comprises the following components, all disposed in the telephone's handset:
input means, for sampling audio/video signal from a user thereof to be sent to another user;
   output means, for displaying the audio/video signal from the other user;
   a user interface, for setting and operating the telephone; and
   a cellular communication module, for communicating with a cellular base station.

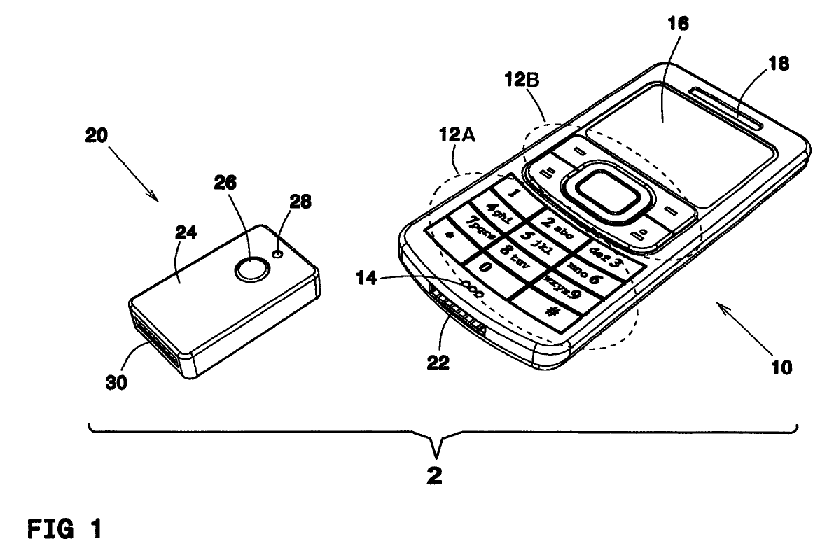

FIG. 1 pictorially illustrates a cellular telephone apparatus 2, according to a preferred embodiment of the invention.

According to this embodiment of the present invention, the cellular telephone apparatus comprises two separate devices:
a handset 10, comprising:
   input means (such as microphone 14), for sampling audio/video signal from a user thereof to be sent to another user;
      output means (such as speaker 18), for displaying the audio/video signal from the other user;
      a short range communication module (not seen in this figure), for communicating with a corresponding cellular communication box 20;
a cellular communication box 20, which comprises:
   a short range communication module (not seen in this figure), for communicating with handset 10; and
      a cellular communication module (not seen in this figure), for communicating with a cellular base station.

Thus, according to this embodiment of the invention, the functionality of the cellular telephone has been divided into two separate physical entities: handset 10, which comprises the user interface components, and a cellular communication box 20 for communicating with a cellular base station. The separate entities 10 and 20 communicate with each other by short-range communication, such as Bluetooth communication.

By separating the cellular communication components from the handset, a user thereof can place the physical box that comprises the communication components away from his head, thereby using the cellular telephone in a “traditional” form, without exposing his head to the same radiation intensity as in the prior art.

Actually, the radiating element of a cellular telephone is the cellular transmitter thereof. However, if the rest of the cellular communication components are disposed in the communication box, when upgrades are available in the communication components, the entire communication box can be replaced by an upgraded device. Furthermore, a user can replace the handset with an upgraded handset, without replacing the communication box. Thus, from a maintenance point of view, the present invention provides an easier device for maintenance, in comparison to the prior art.

In this figure, communication box 20 comprises casing 24, an on/off button 26, an indicator 28, and jack (connector) 30, which is used for charging the battery (not illustrated) of communication box 20. Indicator 28 may be embodied by a LED (Light Emission Diode), which is a lamp that uses a relatively-small amount of current.

The indicator may indicate that the communication between handset 10 and communication box 20 is established, present the strength of the cellular signal, and so on.

The on/off button can be used for turning the communication box on and off. For example, when the communication ability is not required, the user may turn the communication box off, thereby prolonging the time until the next charge of the battery thereof.

Handset 10 uses jack (connector) 22, through which the battery (not illustrated) of handset 10 is charged.

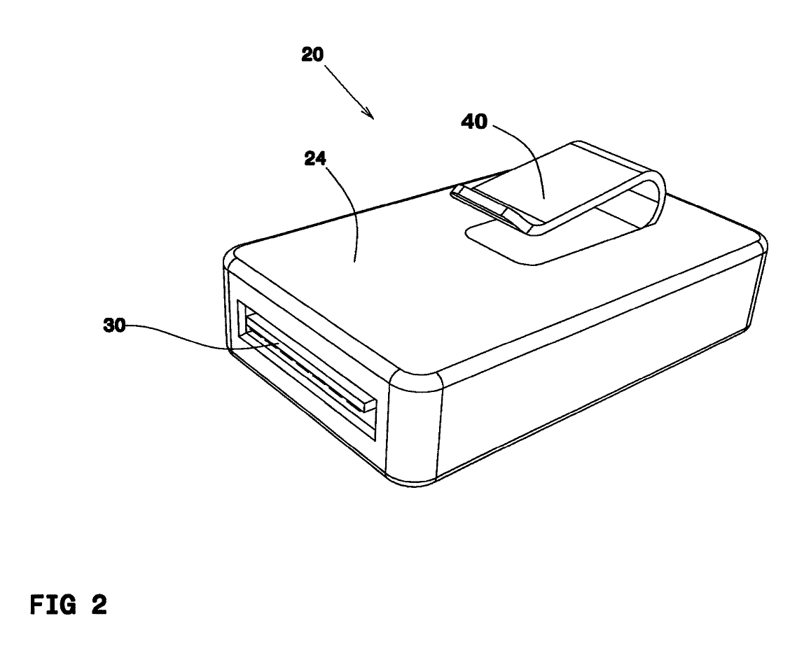

FIG. 2 pictorially illustrates the backside of communication box 20 of FIG. 1.

Numeral 50 denotes a clip, which allows a user to attach the communication box to a belt and the like.

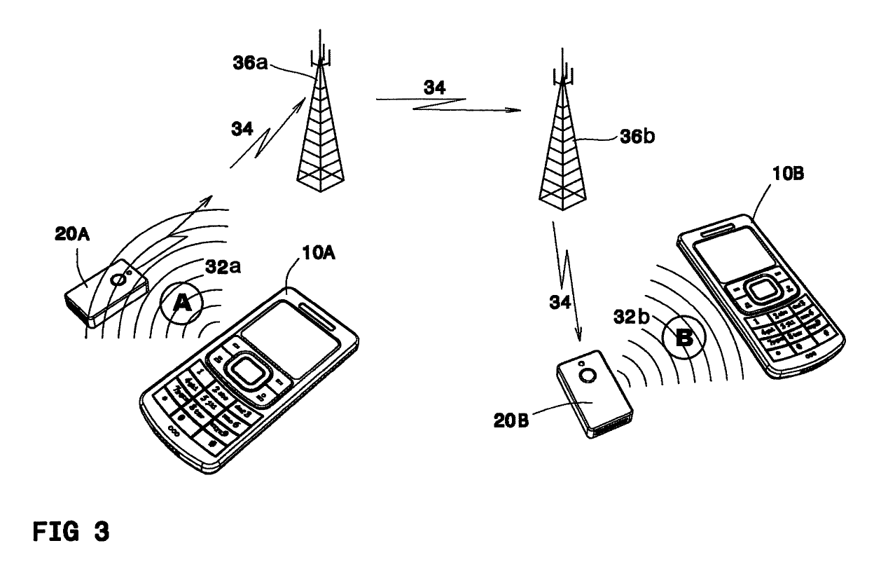

FIG. 3 pictorially illustrates a communication transmission from a cellular telephone A to a cellular telephone B, according to one embodiment of the invention.

Cellular telephone A comprises handset 10A and communication box 20A, and cellular telephone B comprises handset 10B and communication box 20B.
Handset 10A of cellular telephone A transmits a signal by short-range communication 32a to the communication box thereof 20A;
   Communication box 20A transmits the signal by a cellular communication 34 to base station 36a;
   Base station 36a transmits the signal via a cellular network to base station 36b, in the range of which cellular telephone B is presently located;
   Base station 36b transmits signal 34 to communication box 20B of telephone B; and
   Communication box 20B transmits the signal, via a short-range communication 32b, to handset 10B thereof.

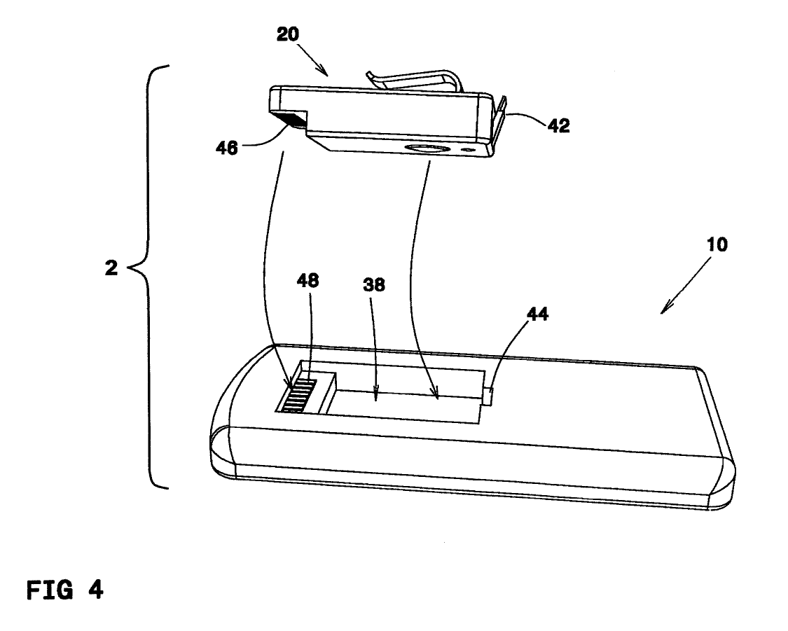

FIG. 4 pictorially illustrates a cellular telephone apparatus, according to another embodiment of the invention.

According to this embodiment of the invention, handset 10 comprises a housing 38 of the communication box thereof 20. Thus, the communication box can be kept installed in the handset thereof, and separated thereof when required.

One of the benefits of this embodiment is that handset 10 and communication box 20 can be load by a single charger (not illustrated), simultaneously. In order to allow this functionality, contacts 46 of communication box 20 must correspond to contacts 48 of handset 10.

Numeral 42 denotes a dowel by which communication box 20 is attached to depression 44 of handset 10.

Preferably, a short range communication distance of about one meter is adequate. However, a communication range of a few meters allows charging the communication box while the handset is held by the user. Thus, the user can charge the communication box while the handset fully functions.

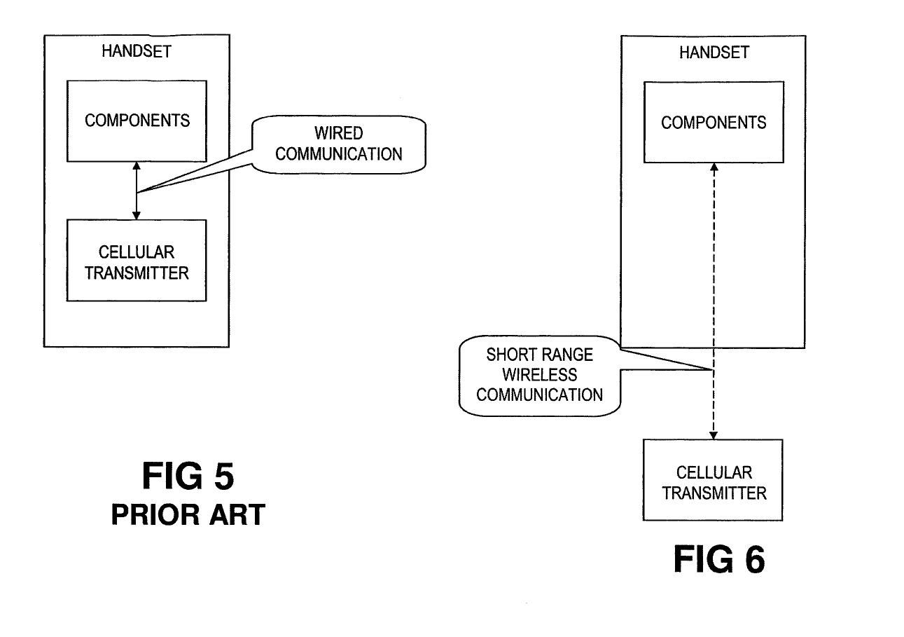

FIGS. 5 and 6 illustrate the difference between the present invention and the prior art.

FIG. 5 is a block diagram illustrating a cellular telephone, according to the prior art.

All the components of the cellular telephone are disposed in a handset thereof, including a cellular transmitter. The communication/connection of the cellular transmitter with the rest of the components is carried out via wired connection, illustrated by a continuous arrow.

FIG. 6 is a block diagram illustrating a cellular telephone, according to one embodiment of the invention.

In this case, the cellular transmitter is disposed in a separate device, away from the handset. The wired communication/connection is replaced by short range wireless communication, which is illustrated by a dashed arrow. Of course the separate device which stores the transmitter must be coupled with a battery and short-range wireless communication means. The handset also must be coupled with corresponding short range wireless communication means.

According to one embodiment of the invention, the short range communication between the handset and the communication box is carried out alternately while not in a telephone conversation with another telephone user (“idle state”), and continuously while in a telephone conversation with another user. For example, every 2 seconds the system checks if a telephone call has been received. Since the majority of the time the telephone is in idle state, a significant amount of battery power is saved, thereby allowing a longer operation period between two subsequent charges.

In the figures and/or description herein, the following reference numerals have been mentioned:
Numeral 2 denotes a cellular telephone apparatus, according to one embodiment of the invention;
   numeral 10 denotes a handset of apparatus 2;
   numeral 12A denotes a keypad of handset 10;
   numeral 12B denotes arrow keys of handset 10;
   numeral 14 denotes a microphone of handset 10;
   numeral 16 denotes a display of handset 10;
   numeral 18 denotes a speaker of handset 10;
   numeral 20 denotes a communication box of apparatus 2;
   numeral 22 denotes a jack (connector) through which the battery of handset 10 is charged;
   numeral 24 denotes a casing of communication box 20;
   numeral 26 denotes an on/off button of communication box 20;
   numeral 28 an indicator of communication box 20;
   numeral 30 denotes a jack (connector) through which the battery of communication box 20 is charged;
   each of numerals 32a and 32b denotes a short-range communication signal;
   numeral 34 denotes cellular communication;
   each of numerals 36a and 36b denotes a cellular communication, i.e., communication within components of a cellular network;
   numeral 38 denotes a housing of a communication box, within a handset thereof;
   numeral 40 denotes a clip;
   numeral 42 denotes a dowel;
   numeral 44 denotes a depression, which generates a locking mechanism with dowel 42;
   numeral 46 denotes contacts of communication box 20 with contacts 48 of handset 10; and
   numeral 48 denotes contacts.

The foregoing description and illustrations of the embodiments of the invention has been presented for the purposes of demonstration. It is not intended to be exhaustive or to limit the invention to the above description in any form.

Any term that has been defined above and used in the claims, should to be interpreted according to this definition.

What is claimed is:

1. A cellular telephone apparatus, comprising:
a handset; and
a communication box in which is installed at least a cellular transmitter of said apparatus;
wherein said handset and said box are physically separated entities, communicating with each other via short range wireless communication;
thereby allowing a user thereof to carry out cellular communication while keeping said cellular transmitter away from his head.

2. An apparatus according to claim 1, wherein said short range wireless communication complies with the Bluetooth protocol.

3. An apparatus according to claim 1, wherein the range of said short range wireless communication is a distance of about 1 meter, thereby using a relatively low power transmitter.

4. An apparatus according to claim 1, wherein the range of said short range wireless communication is a distance of about 10 meters, thereby allowing utilizing said handset while charging said communication box.

5. An apparatus according to claim 1, wherein said communication box further comprises a cellular receiver, thereby concentrating the cellular communication components of said apparatus nearby each other, resulting in a simplified mechanism and convenient maintenance.

6. An apparatus according to claim 1, wherein said handset further comprises housing for holding therein said box.

7. An apparatus according to claim 6, wherein said housing comprises contacts connected to a charging slot thereof, and said box comprises corresponding contacts, thereby allowing charging said handset and said box simultaneously, by the same charger.

8. An apparatus according to claim 1, wherein said box further comprises a clip, for clipping said box to a garment of said user.

9. An apparatus according to claim 1, wherein said short range communication is carried out alternately on idle time, and continuously while communicating with another user, thereby using a reduced amount of energy.

10. A method for reducing radiation of a cellular telephone to a user's head, the method comprising the steps of:
physically separating the cellular transmitter of said cellular telephone from the handset of said cellular telephone; and
replacing the wired connection of said transmitter with components of said cellular telephone by short range wireless communication means;
thereby allowing disposing said transmitter away from said user's head, resulting in reduced cellular radiation for said transmitter to said user's head.

11. A method according to claim 10, wherein said short range communication is a Bluetooth communication.

12. A method according to claim 10, wherein the range of said short range communication is about 1 meter, thereby using a relatively low power transmitter.

13. A method according to claim 10, wherein the range of said short range communication is a range of about 10 meters, thereby utilizing said handset while charging said communication box.

14. A method according to claim 10, wherein said communication box further comprises a cellular receiver, thereby concentrating the cellular communication components of said apparatus in the same vicinity, resulting in a simplified mechanism and convenient maintenance.

15. A method according to claim 10, wherein said short range communication is carried out alternately on idle time, and continuously while communicating with another user, thereby using a reduced amount of energy.
